(19) United States
(12) Patent Application Publication
(10) Pub. No.: US 2024/0224070 A1
(43) Pub. Date: Jul. 4, 2024

(54) MANAGEMENT APPARATUS, MANAGEMENT METHOD, AND MANAGEMENT PROGRAM

(71) Applicant: RAKUTEN MOBILE, INC., Tokyo (JP)

(72) Inventors: Jin NAKAZATO, Tokyo (JP); Saki TANAKA, Tokyo (JP)

(73) Assignee: RAKUTEN MOBILE, INC., Tokyo (JP)

(21) Appl. No.: 17/918,838

(22) PCT Filed: Aug. 20, 2021
(86) PCT No.: PCT/JP2021/030680

§ 371 Date: Oct. 13, 2022

(51) Int. Cl. H04W 24/02; H04L 43/16; H04L 43/20; H04W 88/08

(52) U.S. Cl. CPC H04W 24/02; H04L 43/16; H04L 43/20; H04W 88/085

(57) ABSTRACT

An objective is to provide a management apparatus, a management method, and a management program that can appropriately operate a virtualized DU in a RAN.

A management apparatus (500) manages a virtualized DU (Distributed Unit) in a base station forming a radio communication cell, constructed from one or more virtualized components. A virtualized DU monitoring unit (510) monitors, as a usage status value, a radio terminal accommodation rate in the virtualized DU or a traffic accommodation rate in the virtualized DU. A virtualized DU setting determination unit (520) determines a setting in the virtualized DU based on the usage status value and a deletion allowance requirement. The virtualized DU setting determination unit (520) determines that the virtualized DU is to be deleted if the usage status value is less than a first threshold value and the deletion allowance requirement is satisfied, and determines that the virtualized DU is to be scaled in if the usage status value is less than the first threshold value and the deletion allowance requirement is not satisfied.

### TECHNICAL FIELD

The present invention relates to a management apparatus, a management method, and a management program for managing a virtualized DU (Distributed Unit) provided in a base station forming a radio communication cell.

### BACKGROUND

In 5th-generation mobile systems (5G: 5th-Generation mobile communication systems) or Beyond 5G/6G systems that are being considered as next-generation communication schemes, the use of higher carrier frequencies with wider frequency bandwidths in comparison with LTE (long term evolution)/LTE-Advanced systems in order to obtain higher speeds and higher capacities is being considered.

Base stations that can be adapted for realizing high speeds and high capacities use dedicated servers that have been designed and developed to have hardware, such as FPGAs (Field-Programmable Gate Arrays), CPUs (Central Processing Units)/GPUs (Graphics Processing Units), MEMs (Multi-Access Edge Computing), disks, and memory, with specifications capable of processing the maximum communication traffic volume. However, there is a problem in that it is difficult to flexibly make design changes to a dedicated server after manufacture.

In recent years, the application of virtualization technology has been considered in various fields. In 5G systems as well, virtualization progressed first in core networks (CNs: Core Networks), and this has been followed by interest being directed towards the virtualization of radio access networks (RANs: Radio Access Networks).

In virtualization technology, servers are divided into logical units without being limited by their physical configurations, and virtual nodes that each function as logical computers using independent operating systems are used. Patent Document 1 considers a method for appropriately determining increases or decreases in the number of virtualized components constituting a virtual node when operating virtual nodes of multiple types in a CN.

### CITATION LIST

### Patent Literature

Patent Document 1: JP 2015-149578 A

### Non-Patent Literature

Non-Patent Document 1: ETSI GS NFV 002 V1.2.1 (2014-12) Network Functions Virtualisation (NFV); Architectural Framework (retrieved Jul. 27, 2021) <http://www.etsi.org/deliver/etsi_gs/NFV/001_099/002/01.02.01_60/gs_NFV002v010201 p.pdf>

### SUMMARY OF INVENTION

### Technical Problem

However, although Patent Document 1 considers the operation of various types of virtual nodes in a CN, the operation of a virtualized DU (vDU: virtualized Distributed Unit), which is one of the virtual nodes in a RAN, is not considered.

An objective of the present invention is to provide technology that can appropriately operate a virtualized DU in a RAN.

### Solution to Problem

One embodiment of the management apparatus according to the present invention is a management apparatus that manages a virtualized DU (Distributed Unit) in a base station forming a radio communication cell, constructed from one or more virtualized components, wherein the management apparatus comprises: a virtualized DU monitoring unit that monitors, as a usage status value, a radio terminal accommodation rate in the virtualized DU or a traffic accommodation rate in the virtualized DU; a virtualized DU setting determination unit that determines a setting in the virtualized DU based on the usage status value and a deletion allowance requirement; and a control unit that controls the virtualized DU in accordance with the setting that has been determined, wherein the virtualized DU setting determination unit determines that the virtualized DU is to be deleted if the usage status value is less than a first threshold value and the deletion allowance requirement is satisfied, and determines that the virtualized DU is to be scaled in if the usage status value is less than the first threshold value and the deletion allowance requirement is not satisfied.

In one embodiment of the management apparatus according to the present invention, the virtualized DU setting determination unit determines that the virtualized DU is to be scaled in if the usage status value is equal to or higher than the first threshold value and less than a second threshold value higher than the first threshold value, determines that the virtualized DU is to be maintained if the usage status value is equal to or higher than the second threshold value and less than a third threshold value higher than the second threshold value, determines that the virtualized DU is to be scaled out if the usage status value is equal to or higher than the third threshold value and less than a fourth threshold value higher than the third threshold value, and determines that a virtualized component is to be added to the virtualized DU if the usage status value is equal to or higher than the fourth threshold value

In one embodiment of the management apparatus according to the present invention, if the virtualized DU setting determination unit has determined that the virtualized DU is to be maintained in a case in which the usage status value is equal to or higher than the second threshold value and less than the third threshold value higher than the second threshold value, the virtualized DU setting determination unit further determines that the virtualized DU is to be scaled in if a decrease rate in the usage status value is equal to or higher than a fifth threshold value, and determines that the virtualized DU is to be scaled out if an increase rate in the usage status value is equal to or higher than a sixth threshold value.

One embodiment of the management method according to the present invention is a management method for managing a virtualized DU (Distributed Unit) in a base station forming a radio communication cell, constructed from one or more virtualized components (contemplated to be virtual machines or containers), wherein the management method includes: a step of monitoring, as a usage status value, a radio terminal accommodation rate in the virtualized DU or a traffic accommodation rate in the virtualized DU; and a step of determining a setting in the virtualized DU based on the usage status value and a deletion allowance requirement, wherein the step of determining the setting in the virtualized DU setting involves determining that the virtualized DU is to be deleted if the usage status value is less than a first threshold value and the deletion allowance requirement is satisfied, and determining that the virtualized DU is to be scaled in if the usage status value is less than the first threshold value and the deletion allowance requirement is not satisfied.

One embodiment of the management program according to the present invention makes one or more processors execute the respective units in the above-mentioned management apparatus.

### Effects of Invention

According to the present invention, a virtualized DU in a RAN can be appropriately operated.

### BRIEF DESCRIPTION OF DRAWINGS

FIG. 1 is a diagram illustrating an example of the configuration of a radio communication system to which the management apparatus according to an embodiment of the present invention is applied.

FIG. 2 is a diagram illustrating functional blocks in NFV reference architecture.

FIG. 3 is a diagram for explaining the configuration of a virtualized DU (vDU: virtualized Distributed Unit).

FIG. 4 is a block diagram illustrating the functional configuration of the management apparatus according to the embodiment.

FIG. 5 is a diagram illustrating an example of the processing sequence of the management method according to the embodiment.

FIG. 6 is a diagram illustrating a flow chart of a determination process in a virtualized DU setting determination unit.

FIG. 7 is a diagram illustrating a flow chart of a determination process in a virtualized DU setting determination unit.

FIG. 8 is a diagram illustrating a computer system for implementing the management apparatus according to the embodiment.

### DESCRIPTION OF EMBODIMENTS

Hereinafter, an embodiment of the present invention will be explained in detail with reference to the drawings.

### EMBODIMENT

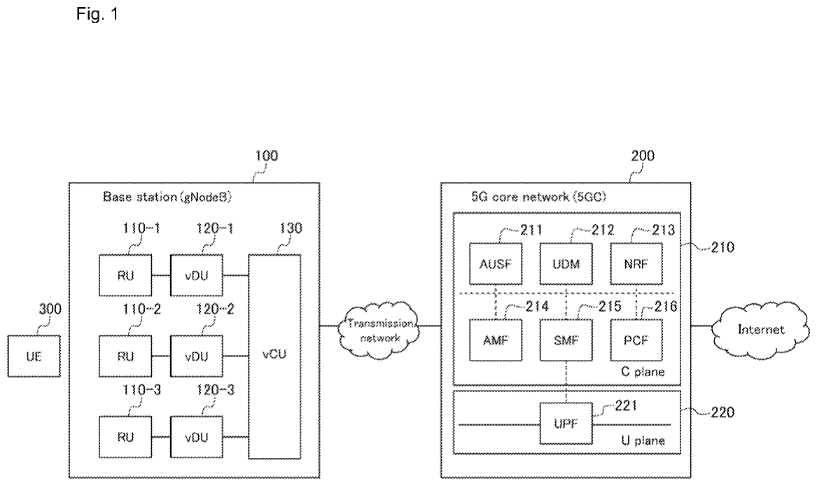

FIG. 1 is a diagram illustrating an example of the functional configuration of a radio communication system to which the management apparatus according to an embodiment of the present invention is applied. FIG. 1 is an example of the functional configuration of a 5G system.

FIG. 1 illustrates an example in which the radio communication system includes a base station 100, a core network (CN: Core Network) 200, and a UE (User Equipment) 300.

The base station 100 in the 5G system, known as a gNB, is configured to include RU (Radio Unit) functions, DU (Distributed Unit) functions, and a CU (Central Unit) function. The RU functions, the CU function, and the DU functions are known as a radio access network (RAN: Radio Access Network), and the CU function in the RAN is connected to the core network (CN) 200.

In the present embodiment, the DU functions and the CU function are respectively constructed as vDUs (virtualized Distributed Units) and a vCU (virtualized Central Unit) by virtualization.

In FIG. 1, the vDUs 120-1, 120-2, 120-3 (hereinafter referred to collectively as vDUs 120) perform layer processes including at least a physical (PHY) layer, and the vCU 130 performs layer processes including a radio resource control (RRC: Radio Resource Management) layer at a level higher than the layers in which the vDUs 120 perform processes. Additionally, multiple vDUs 120 may be connected to a single vCU 130. Additionally, one or more RUs 110-1, 110-2, 110-3 (hereinafter referred to collectively as RUs 110) are connected to a single vDU 120. The RUs 110 form one or more beams, for example, by beam forming, and use one of those beams to establish a connection with the UE. In other words, the base station 100 is configured so as to include a vCU 130, one or more vDUs 120 connected to that vCU 130, and one or more RUs 110 connected to the vDUs 120. Each RU 110 forms one or more beams, thus many beams are formed, and the UE 300 is connected by one of these multiple beams.

FIG. 1 illustrates an example in which the core network 200 is a 5GC network. The core network 200, which is a 5GC network, is configured to include a C plane provided with an AUSF function, a UDM function, an NRF function, an AMF function, an SMF function, and a PCF function, and a U plane provided with a UPF function.

In this case, the AUSF (Authentication Server Function) 211 handles UE authentication.

The UDM (Unified Data Management) 212 stores subscriber contract information or authentication information for AKA (Authentication and Key Agreement) authentication.

The NRF (NF Repository Function) 213 holds profiles of network function instances in the network, and in response to queries, finds, and provides notification of network function instances and NF services provided thereby.

The AMF (Access and Mobility Management Function) 214 terminates an N2 interface and handles functions for registration management RM (Registration Management), connection management CM (Connection Management), and mobility management MM (Mobility Management). Additionally, the AMF 214 selects the AUSF, relays UE authentication procedures, and manages security keys. Additionally, the AMF 214 selects the SMF for session management SM and relays SM messages between the UE and the SMF.

The SMF (Session Management Function) 215 handles functions for session management SM, manages the assignment of IP addresses to UEs, and selects and controls the UPF (User Plane Function).

The PCF (Policy Control Function) 216 holds various policy rules and provides the various policy rules to the C plane functions for implementing policies.

The UPF (User Plane Function) 221 routes and transfers user packets for PDU sessions, and handles a connection point function for a data network, an anchor point function at the time of handover, a policy control implementation function, a traffic usage amount monitoring function, and the like.

Additionally, in FIG. 1, the UE (User Equipment) 300 is a radio terminal (hereinafter sometimes referred to as a terminal or a UE) served by the base station 100.

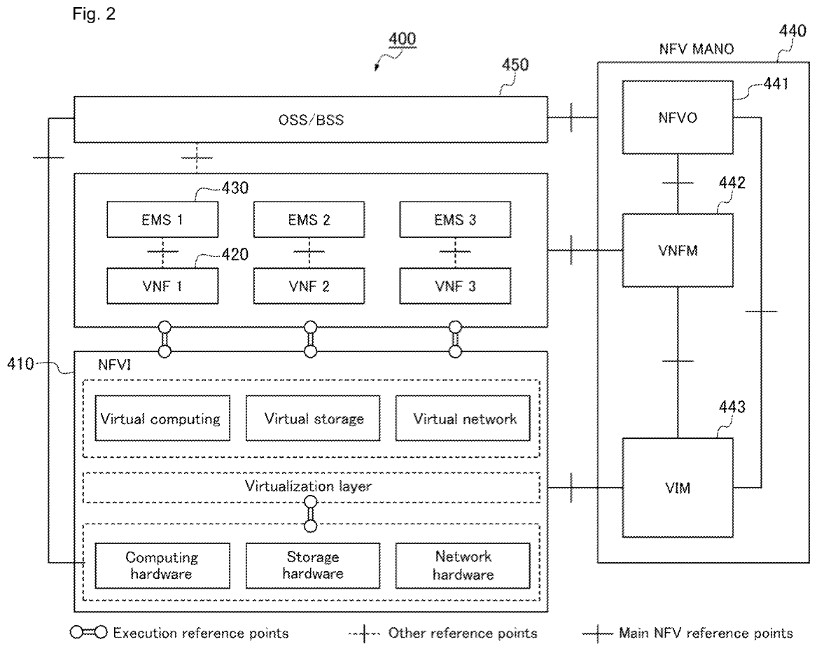

FIG. 2 is a diagram illustrating a functional block in NFV reference architecture 400 in a virtualized network proposed under the ETSI (European Telecommunication Standards Institute) standards (see Non-Patent Document 1).

The NFVI (Network Function Virtualization Infrastructure) 410 realizes the hardware resources of a physical machine (server), such as computing, storage, and network functions, as virtualized computing, virtualized storage, or a virtualized network, which are virtualized on a virtualized layer such as a hypervisor (Hypervisor). The NFVI 410 is a virtualization infrastructure (Virtualization Infrastructure) for VNFs (Virtual Network Functions) 420.

The NVFs 420 are application software for network functions installed so as to operate on the NFVI 410. The VNFs will sometimes be referred to as virtual nodes.

In FIG. 1, the DU functions and the CU function in the RAN, and the AUSF function, the UDM function, the NRF function, the AMF function, the SMF function, the PCF function, and the UPF function in the CN correspond to the VNFs in FIG. 2.

Returning to FIG. 2, the EMSs (Element Management Systems) 430 are management functions for FCAPS (Fault, Configuration, Accounting, Performance, Security) regarding the VNFs.

The NFV MANO (Management and Orchestration) 440 provides hardware resource and software resource management, as well as a VNF management function and an orchestration function. The NFV MANO 440 is configured from an NFVO (NFV Orchestrator) 441, a VNFM (VNF Manager) 442, and a VIM (Virtualized Infrastructure Manager) 443.

The NFVO 441 manages and orchestrates the NFVI 410 and the VNFs 420 and realizes network services (allocation of resources to the VNFs and management of the VNFs 420 (for example, autohealing (automatic fault reconfiguration), autoscaling, life cycle management of the VNFs 420, etc.)) on the NFVI 410.

The VNFM 442 manages the life cycles (for example, generation, updates, queries, healing, scaling, termination, etc.) of the VNFs 420 and provides event notification.

The VIM 443 controls the NFVI 410 (for example, managing computing, storage, and network resources, fault monitoring the NFVI 410, which is the infrastructure on which the VNFs 420 are executed, monitoring resource information, etc.) via a virtualized layer.

Additionally, in FIG. 2, of the OSS/BSS 450, OSS (Operations Support Systems) is a collective term for the systems (devices or software, arrangements, etc.) necessary, for example, for a communication provider (carrier) to construct and operate services. BSS (Business Support Systems) is a collective term for information systems (devices or software, mechanisms, etc.) used, for example, by a communication provider (carrier) for charging and billing usage fees, responding to customers, or the like.

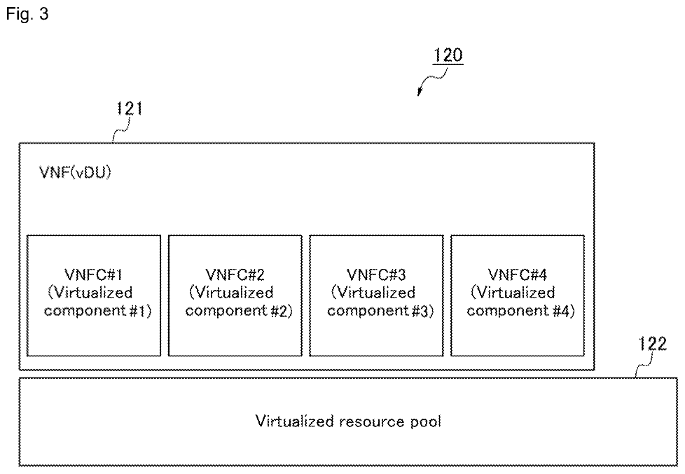

FIG. 3 is a diagram for explaining the configuration of a virtualized DU (vDU: virtualized Distributed Unit) provided in the base station 100 forming a radio communication cell managed by the management apparatus according to the present embodiment. FIG. 3 is an example of the case in which the vDU 120 is constructed in accordance with the NFV reference architecture illustrated in FIG. 2. The DU functions in the base station 100 are defined as VNFs in NFV reference architecture. Hereinafter, a DU function defined as a VNF will be referred to as a VNF (vDU) 121.

The VNF (vDU) 121 comprises one or more VNFCs. FIG. 3 illustrates an example in which the VNF (vDU) 121 is constructed from four VNFCs (Virtualized Network Function Components) #1, #2, #3, #4. The VNFCs by which the VNF (vDU) 121 is constructed are virtualized components by which the vDU 120 is constructed. In NFV reference architecture, VNFCs are also referred to as virtual machines (VMs: Virtual Machines).

The maximum number of VNFCs provided in a VNF (vDU) 121 is determined in accordance with the size of a virtualized resource pool 122 that can be allocated for construction of the VNF (vDU) 121. In this case, the virtualized resource pool 122 is a virtualized infrastructure for the VNF (vDU) 121, corresponding to the NFVI 410 in FIG. 2. The VNFCs (virtualized components) by which the VNF (vDU) 121 is constructed are installed in the virtualized resource pool 122.

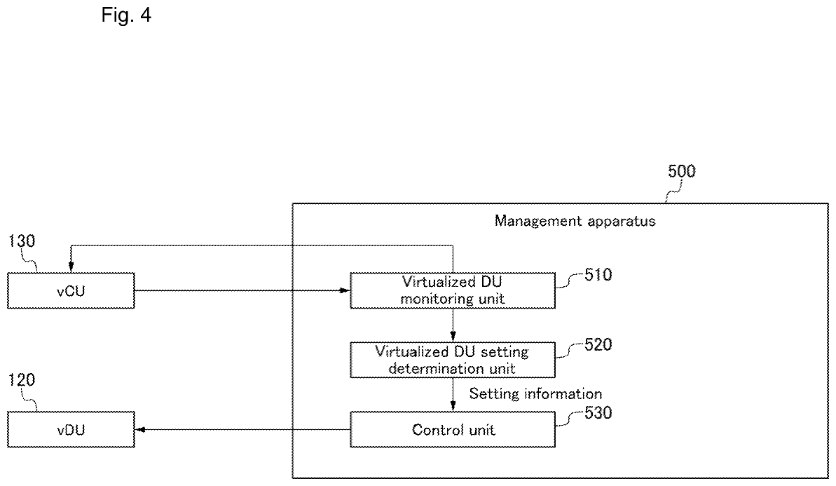

Next, a management apparatus 500 according to the present embodiment will be explained by using FIG. 4. FIG. 4 is a block diagram illustrating the functional configuration of the management apparatus 500 according to the present embodiment.

The management apparatus 500 manages the vDU 120 provided in the base station 100 forming the radio communication cell. As mentioned above, in the case in which the DU functions are constructed by means of virtualization technology in accordance with NFV reference architecture, the DU functions are defined as VNFs. Hereinafter, an example of the case in which a VNF defined as a DU function is constructed from four VNFCs #1, #2, #3, #4, as illustrated in FIG. 3, will be described.

The management apparatus 500 comprises a virtualized DU monitoring unit 510, a virtualized DU setting determination unit 520, and a control unit 530.

The virtualized DU monitoring unit 510 monitors, as a usage status value, the radio terminal accommodation rate in the vDU 120 or the traffic accommodation rate in the vDU 120. For example, the virtualized DU monitoring unit 510 notifies the vCU 130 in the base station 100 of a request for transmission of the usage status value. When notified of the request, the vCU 130 notifies the virtualized DU monitoring unit 510 of information regarding at least one of the number of radio terminals and the traffic volume served by the vDU 120 provided in the base station 100.

The virtualized DU monitoring unit 510 acquires, from the vCU 130, the information regarding at least one of the number of radio terminals and the traffic volume for each VNFC included in the VNF (vDU) 121 by which the vDU 120 is constructed. That is, in the case in which the VNF (vDU) 121 comprises four VNFCs #1, #2, #3, #4 as illustrated in FIG. 3, the virtualized DU monitoring unit 510 monitors at least one of the number of radio terminals and the traffic volume processed by the four VNFCs #1, #2, #3, #4, and computes the total thereof to compute the number of radio terminals or the traffic volume being served by the base station 100.

Furthermore, the virtualized DU monitoring unit 510 computes, as a usage status value, the radio terminal accommodation rate or the traffic accommodation rate based on the number of radio terminals or the traffic volume being served by the vDU 120.

The radio terminal accommodation rate is the fraction of the number of radio terminals actually being served by the vDU 120 relative to the maximum number of accommodated radio terminals that can be served by the vDU 120.

The traffic accommodation rate is the fraction of the traffic volume actually being served by the vDU 120 relative to the maximum traffic volume that can be served by the vDU 120.

The maximum number of accommodated radio terminals and the maximum traffic volume can be determined in accordance with the size of the virtualized resource pool 122 that can be allocated to the VNF (vDU) 121 by which the vDU 120 is constructed.

In this way, the virtualized DU monitoring unit 510 monitors the radio terminal accommodation rate or the traffic accommodation rate, and notifies the virtualized DU setting determination unit 520 thereof as a usage status value.

The virtualized DU setting determination unit 520 determines a setting in the vDU 120 based on the usage status value and a deletion allowance requirement.

Specifically, the virtualized DU setting determination unit 520 compares the usage status value with a prescribed threshold value. Furthermore, the virtualized DU setting determination unit 520 determines whether or not the deletion allowance requirement is satisfied. The deletion allowance requirement is a requirement for allowing the vDU 120 to be deleted. The prescribed threshold value and the deletion allowance requirement will be explained below.

Furthermore, the virtualized DU setting determination unit 520 determines the setting in the vDU 120 based on a comparison result between the usage status value and the prescribed threshold value, and an assessment result regarding whether or not the deletion allowance requirement is satisfied.

Specifically, the virtualized DU setting determination unit 520 determines, as a setting in the vDU 120, whether the vDU 120 is to be deleted, scaled in, or scaled out, or a VNFC is to be added. The setting determination method in the virtualized DU setting determination unit 520 will be explained below.

The virtualized DU setting determination unit 520 notifies the control unit 530 of the determined setting information for the vDU 120.

The control unit 530 controls the vDU 120 in accordance with the determined setting. The control unit 530 may, as the control method, for example, control the vDU 120 in accordance with the determined setting by using the functions of the NFV MANO (Management and Orchestration) 440 in FIG. 2. In this case, the control unit 530 controls the respective functional blocks in the NFV reference architecture of the virtualized network described by using FIG. 2 so as to adopt the setting determined by the virtualized DU setting determination unit 520.

For example, in the case in which the virtualized DU setting determination unit 520 has determined, as the setting in the vDU 120, that the vDU 120 is to be deleted, the control unit 530 controls the respective functional blocks so as to delete the VNFCs included in the VNF (vDU) 121 by which the vDU 120 is constructed.

Additionally, in the case in which the setting in the vDU 120 has been determined to be that for scaling in the vDU 120, the control unit 530, for example, controls the respective functional blocks so as to delete or scale in at least one of the VNFCs included in the VNF (vDU) 121 by which the vDU 120 is constructed.

Additionally, in the case in which the setting in the vDU 120 has been determined to be that for maintaining the vDU 120, the control unit 530 controls the respective functional blocks so as to maintain all of the VNFCs included in the VNF (vDU) 121 by which the vDU 120 is constructed.

Additionally, in the case in which the setting in the vDU 120 has been determined to be that for scaling out the vDU 120, the control unit 530, for example, controls the respective functional blocks so as to allocate more virtualized resources to at least one of the VNFCs included in the VNF (vDU) 121 by which the vDU 120 is constructed, thereby scaling out the VNFCs.

Additionally, in the case in which the setting in the vDU 120 has been determined to be that for adding a virtualized component to the vDU 120, the control unit 530, for example, controls the respective functional blocks so as to newly add a VNFC to the VNF (vDU) 121 by which the vDU 120 is constructed.

In this way, the control unit 530 deploys the vDU 120 in accordance with the determined setting.

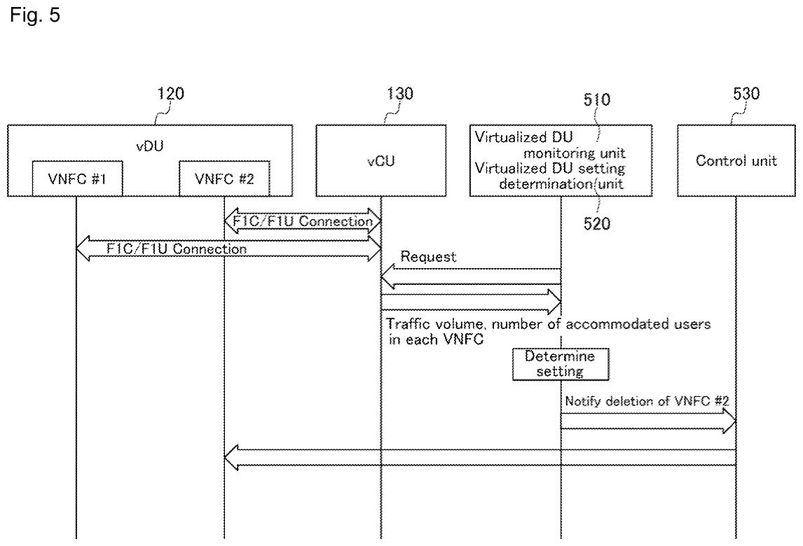

Next, the management method according to the present embodiment will be described by using FIG. 5. FIG. 5 illustrates an example of a processing sequence for determining a setting in the vDU 120. In FIG. 5, the VNFC #1 and the VNFC #2 are virtualized components by which the VNF (vDU) 121 of the vDU 120 is constructed. FIG. 5 illustrates an example wherein the VNF (vDU) 121 is constructed from two VNFCs (VNFC #1 and VNFC #2).

As illustrated in FIG. 5, the vCU 130 in the base station 100 establishes an F1-C connection and an F1-U connection with the VNFC #1. Additionally, the vCU 130 in the base station 100 establishes an F1-C connection and an F1-U connection with the VNFC #2. In this case, an F1-C connection is a control plane connection via an F1 interface. An F1-C connection is a user plane connection via an F1 interface.

The virtualized DU monitoring unit 510 requests the vCU 130 in the base station 100 to acquire and transmit a usage status value.

Upon acquiring the request from the virtualized DU monitoring unit 510, the vCU 130 in the base station 100 acquires information regarding the number of radio terminals or the traffic volume being served by each VNFC, and notifies the virtualized DU monitoring unit 510 of the number of radio terminals or the traffic volume that has been acquired.

The virtualized DU monitoring unit 510 computes the total number of radio terminals or traffic volume processed by the two VNFCs #1, #2 to compute, as the usage status value, the number of radio terminals or the traffic volume being served by the base station 100.

The virtualized DU setting determination unit 520 determines the setting in the vDU 120 based on a comparison result between the usage status value in the vDU 120 and a prescribed threshold value, and an assessment result regarding whether or not the deletion allowance requirement is satisfied, and notifies the control unit 530 of the determination result. The method for determining the setting in the vDU 120 in the virtualized DU setting determination unit 520 will be explained below.

The control unit 530 controls the vDU 120 in accordance with the determination result by using, for example, the functions of the NFV MANO (Management and Orchestration) 440 in FIG. 2.

FIG. 5 illustrates an example of the case in which the virtualized DU setting determination unit 520 has determined, as the setting in the vDU 120, that the vDU 120 is to be scaled in. FIG. 5 illustrates an example of a scale-in method in the case in which, of the VNFC #1 and the VNFC #2 included in the VNF (vDU) 121, it has been determined that the VNFC #2 is to be deleted. By deleting a VNFC, in the case in which the vDU 120 is to be scaled in, the virtualized DU setting determination unit 520 may determine that the VNFC with the lowest activity rate among the VNFCs included in the VNF (vDU) 121 is to be deleted.

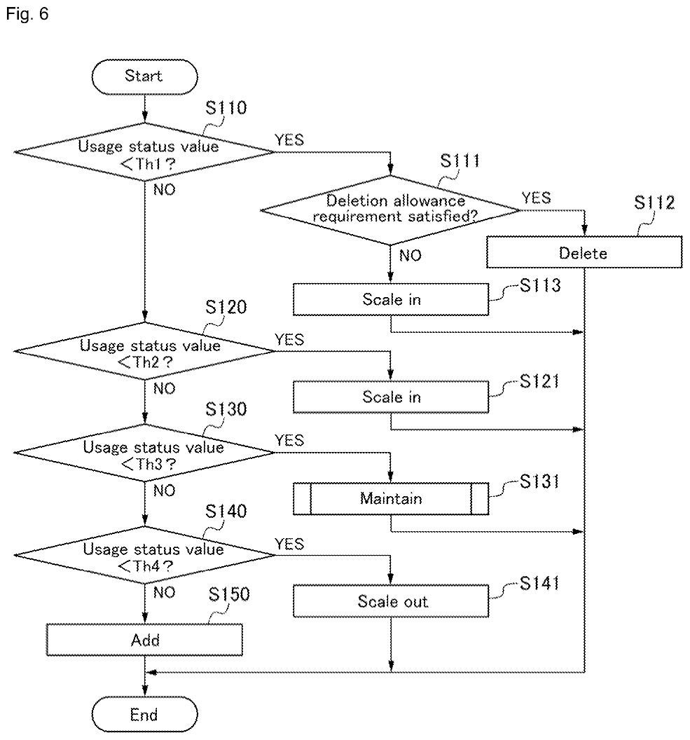

Next, the process for determining the setting in the vDU 120 in the virtualized DU setting determination unit 520 will be described using FIG. 6.

In the case in which the usage status value is less than a first threshold value (Th1) (S110: YES) and the deletion allowance requirement is satisfied (S111: YES), the virtualized DU setting determination unit 520 determines that the vDU 120 is to be deleted (S112).

Additionally, in the case in which the usage status value is less than the first threshold value (S110: YES) and the deletion allowance requirement is not satisfied (S411: NO), the virtualized DU setting determination unit 520 determines that the vDU 120 is to be scaled in (S113).

In this case, the first threshold value is the value of the radio terminal accommodation rate or the traffic accommodation rate that is predicted when there is no session establishment request to the base station 100 from a radio terminal.

Additionally, as explained above, the deletion allowance requirement is a requirement for allowing the vDU 120 to be deleted. Examples of the deletion allowance requirement in the case in which there is one VNFC included in the vDU 121 include:
a state in which the usage status value is less than the first threshold value continuing for a prescribed time period;
a state in which the usage status value is less than the first threshold value occurring a prescribed number of times or more within a prescribed time period;
the hour of day being one during which the base station 100 is not used; or
a heterogeneous network being formed in the radio communication cell formed by the base station 100.

Situations wherein, for example, a state in which the usage status value is less than the first threshold value continues for a prescribed time period or occurs a prescribed number of times or more within a prescribed time period, or wherein the hour of day is one during which the base station 100 is not used can be considered to be situations in which there is very little communication demand or there is no communication demand for the base station 100. Additionally, in situations wherein a heterogeneous network is formed in the radio communication cell formed by the base station 100, there can be considered to be little impact on a radio terminal due to not being able to establish a session with the base station 100. For this reason, the virtualized DU setting determination unit 520 is configured to determine that the vDU 120 is to be deleted only in such situations.

That is, the deletion allowance requirement is a condition in which there is very little communication demand for the base station 100 and/or a condition in which a radio terminal will be little affected by being unable to establish a session with the base station 100.

In other words, the virtualized DU setting determination unit 520 performs a first determination in accordance with whether or not the usage status value is less than the first threshold value. Specifically, if the usage status value is less than the first threshold value, then the virtualized DU setting determination unit 520 determines, as a first determination, that the vDU 120 is to be deleted. There are cases that are undesirable for the purposes of saving power if the vDU 120 is deleted in accordance with the first determination result and a situation occurs in which the vDU 120 must be activated immediately thereafter. Therefore, in the present embodiment, a second determination is further performed regarding whether or not the vDU 120 is to be deleted based on an assessment result regarding whether or not the deletion allowance requirement is satisfied. The virtualized DU setting determination unit 520 determines, as the second determination, that the vDU 120 is to be deleted only in the case in which the deletion allowance requirement is satisfied. Conversely, in the case in which the deletion allowance requirement is not satisfied, the virtualized DU setting determination unit 520 determines, as the second determination, that the vDU 120 is to be scaled in. For example, at least one of the VNFCs (virtualized components) by which the vDU 120 is constructed may be scaled in or deleted to scale in the vDU 120.

In this way, the virtualized DU setting determination unit 520 makes the first determination in accordance with whether or not the usage status value is less than the first threshold value, and further makes the second determination in accordance with whether or not the deletion allowance requirement is satisfied. In other words, the virtualized DU setting determination unit 520 performs a two-step determination and sets the second determination result in the vDU 120.

The deletion allowance requirement may be set based on past usage circumstances in the radio communication cell formed by the base station 100.

Additionally, the deletion allowance requirement may be set in accordance with what kind of value is set for the first threshold value. For example, in the case in which the first threshold value is a value close to zero, the deletion allowance requirement may be set to a requirement allowing deletion at any time. Additionally, the first threshold value may be set in accordance with what kind of requirement is set as the deletion allowance requirement. For example, in the case in which the deletion allowance requirement is a requirement that the vDU 120 must never be deleted, the first threshold value may be set to a value suitable for scaling in the VNFCs. In this case, the processes from S120 onward explained below may be skipped and the vDU 120 may be scaled in.

By having the virtualized DU setting determination unit 520 determine the setting in the vDU 120 based on the usage status value and the deletion allowance requirement in this way, power consumption in the base station 100 can be reduced while avoiding loss of availability of radio terminals.

Returning to FIG. 6, in the case in which the usage status value is equal to or higher than the first threshold value (S110: NO) and less than a second threshold value (Th2) higher than the first threshold value (S120: YES), the virtualized DU setting determination unit 520 determines that the vDU 120 is to be scaled in (S121). The virtualized DU may be scaled in by scaling in or deleting at least one of the VNFCs (virtualized components) by which the vDU 120 is constructed. In the case in which the vDU 121 is constructed from multiple VNFCs, the virtualized DU setting determination unit 520 may determine that the VNFC with the lowest activity rate is to be scaled in.

Additionally, in the case in which the usage status value is equal to or higher than the second threshold value (S120: NO) and less than a third threshold value (Th3) higher than the second threshold value (S130: YES), the virtualized DU setting determination unit 520 determines that the vDU 120 is to be maintained (S131).

Additionally, in the case in which the usage status value is equal to or higher than the third threshold value (S130: NO) and less than a fourth threshold value (Th4) higher than the third threshold value (S140: YES), the virtualized DU setting determination unit 520 determines that the vDU 120 is to be scaled out (S141). The vDU 120 may be scaled out by scaling out at least one VNFC (virtualized component) by which the vDU 120 is constructed.

Additionally, in the case in which the usage status value is equal to or higher than the fourth threshold value (S140: NO), the virtualized DU setting determination unit 520 determines that a VNFC (virtualized component) is to be added to the vDU 120 (S150).

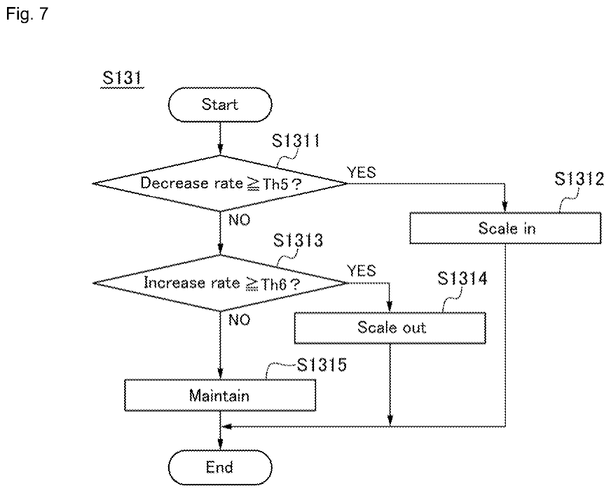

In S131, the setting in the vDU 120 may be further determined, as indicated below, based on a decrease rate and/or an increase rate in the usage status value. Hereinafter, the process for determining the setting in the vDU 120 based on the decrease rate and/or the increase rate in the usage status value will be described using FIG. 7.

In the case in which the usage status value is equal to or higher than the second threshold value (S120: NO) and less than a third threshold value higher than the second threshold value (S130: YES), and further, the decrease rate in the usage status value is equal to or higher than a fifth threshold value (Th5) (S1311: YES), the virtualized DU setting determination unit 520 may determine that the vDU 120 is to be scaled in (S1312).

Additionally, in the case in which the increase rate in the usage status value is equal to or higher than a sixth threshold value (Th6) (S1313: YES), the vDU setting determination unit 520 may determine that the vDU 120 is to be scaled out (S1314).

Additionally, in the case in which the increase rate in the usage status value is less than the sixth threshold value (S1313: NO), the vDU setting determination unit 520 may determine that the vDU 120 is to be maintained (S1315).

By having the virtualized DU setting determination unit 520 determine the setting in the vDU 120 based on the decrease rate and/or the increase rate in the usage status value, the vDU 120 can be deployed to an appropriate setting within a shorter time period in the case in which the communication usage status has suddenly changed in the radio communication cell formed by the base station 100.

As described above, in the present embodiment, the virtualized DU monitoring unit 510 monitors the radio terminal accommodation rate in the vDU 120 or the traffic accommodation rate in the vDU 120 as a usage status value. The virtualized DU setting determination unit 520 determines the setting in the vDU 120 based on the usage status value and the deletion allowance requirement. The virtualized DU setting determination unit 520 determines that the vDU 120 is to be deleted in the case in which the usage status value is less than a first threshold value and the deletion allowance requirement is satisfied, and determines that the vDU 120 is to be scaled in in the case in which the usage status value is less than the first threshold value and the deletion allowance requirement is not satisfied.

By doing so, virtualized resources allocated to construction of the vDU 120 can be deleted, and as a result thereof, the power consumption in the vDU 120 can be reduced.

Additionally, in the present embodiment, the virtualized DU monitoring unit 510 can determine the setting in the vDU 120 in accordance with comparison results between the usage status value and the second, third, fourth, fifth, and sixth threshold values. As a result thereof, virtualized resources of an appropriate size can be allocated to the vDU 120.

The respective threshold values mentioned above may be set so as to be changeable, and may be changed in accordance with the conditions regarding available resources in the virtualized resource pool. Additionally, the deletion allowance requirement may be changed in accordance with the conditions in which the base station 100 is installed.

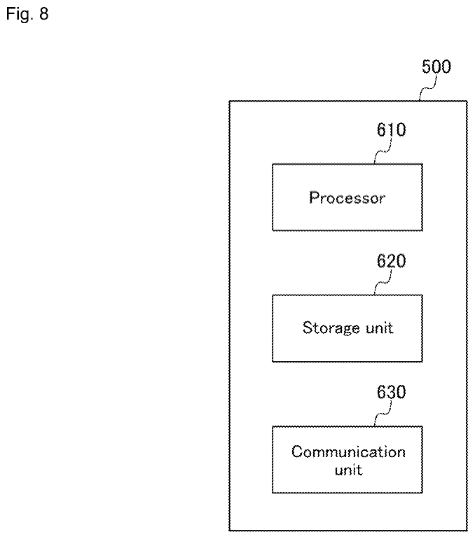

FIG. 8 is a diagram illustrating a computer system for implementing the management apparatus 500 according to the present embodiment. The management apparatus 500 includes a processor 610, a storage unit 620, and a communication unit 630. The numbers of the processor 610, the storage unit 620, and the communication unit 630 are not limited, and there may be one or more. Additionally, the processor 610, the storage unit 620, and the communication unit 630 may be located together at the places in which the respective units constituting the control system 800 are located. The processor 610 is a program control device such as a microprocessor that operates in accordance with a program installed in the control system 800. The storage unit 620 is a storage element such as a ROM or a RAM, or a storage device such as a solid-state drive (SSD) or a hard disk drive (HDD). The storage unit 620 stores a program or the like to be executed by a processor 22. The communication unit 630 is a communication interface such as, for example, an NIC or a wireless LAN module. SDN (Software-Defined Networking) may be installed in the communication unit 630. The communication unit 630 exchanges data with a base station 100, a core network 200, or a control unit 530.

In the description above, an example of the case in which the vDU 120 is constructed in accordance with NFV reference architecture was described. However, the vDU 120 may be constructed by applying container-type virtualization technology. In the case in which the vDU 120 is constructed by applying container-type virtualization technology, the virtualized DU setting determination unit 520 may determine the setting in the vDU 120 by using containers as virtualized components, instead of VNFCs.

The present invention is not limited to the configurations mentioned above, and the present invention also includes a control program. Specifically, a control program for making one or more processors execute the respective units in the management apparatus 500 is also included in the present invention.

Aside from the above, the settings indicated in the above-mentioned embodiments and modified examples may be selectively adopted or removed, or may be appropriately changed to other settings, as long as they do not depart from the spirit of the present invention.

### REFERENCE SIGNS LIST

100 Base station
110, 110-1, 110-2, 110-3 RU
120, 120-1, 120-2, 120-3 vDU
121 VNF (vDU)
122 Virtualized resource pool
130 vCU
200 Core network (CN)
211 AUSF (Authentication Server Function)
212 UDM (Unified Data Management)
213 NRF (NF Repository Function)
214 AMF (Access and Mobility Management Function)
215 SMF (Session Management Function)
216 PCF (Policy Control Function) 216
221 UPF (User Plane Function)
300 UE (User Equipment)
400 NFV reference architecture
410 NFVI (Network Function Virtualization Infrastructure)
420 VNF (Virtual Network Function)
430 EMS (Element Management System)
440 NFV MANO (Management and Orchestration)
441 NFVO (NFV Orchestrator)
442 VNFM (VNF Manager)
443 VIM (Virtualized Infrastructure Manager)
450 OSS/BSS
500 Management apparatus
510 Virtualized DU monitoring unit
520 Virtualized DU setting determination unit
530 Control unit
610 Processor
620 Storage unit
630 Communication unit

1. A management apparatus that manages a virtualized Distributed Unit (DU) in a base station forming a radio communication cell, constructed from one or more virtualized components, wherein the management apparatus comprises:
a virtualized DU monitoring unit that monitors, as a usage status value, a radio terminal accommodation rate in the virtualized DU or a traffic accommodation rate in the virtualized DU;
a virtualized DU setting determination unit that determines a setting in the virtualized DU based on the usage status value and a deletion allowance requirement; and
a control unit that controls the virtualized DU in accordance with the setting that has been determined,
wherein the virtualized DU setting determination unit
determines that the virtualized DU is to be deleted if the usage status value is less than a first threshold value and the deletion allowance requirement is satisfied, and
determines that the virtualized DU is to be scaled in if the usage status value is less than the first threshold value and the deletion allowance requirement is not satisfied.

2. The management apparatus according to claim 1, wherein
the virtualized DU setting determination unit
determines that the virtualized DU is to be scaled in if the usage status value is equal to or higher than the first threshold value and less than a second threshold value higher than the first threshold value,
determines that the virtualized DU is to be maintained if the usage status value is equal to or higher than the second threshold value and less than a third threshold value higher than the second threshold value,
determines that the virtualized DU is to be scaled out if the usage status value is equal to or higher than the third threshold value and less than a fourth threshold value higher than the third threshold value, and
determines that a virtualized component is to be added to the virtualized DU if the usage status value is equal to or higher than the fourth threshold value.

3. The management apparatus according to claim 2, wherein
if the virtualized DU setting determination unit has determined that the virtualized DU is to be maintained in a case in which the usage status value is equal to or higher than the second threshold value and less than the third threshold value higher than the second threshold value,
the virtualized DU setting determination unit further:
determines that the virtualized DU is to be scaled in if a decrease rate in the usage status value is equal to or higher than a fifth threshold value, and
determines that the virtualized DU is to be scaled out if an increase rate in the usage status value is equal to or higher than a sixth threshold value.

4. A management method for managing a virtualized Distributed Unit (DU) in a base station forming a radio communication cell, constructed from one or more virtualized components, wherein the management method includes:
monitoring, as a usage status value, a radio terminal accommodation rate in the virtualized DU or a traffic accommodation rate in the virtualized DU; and
determining a setting in the virtualized DU based on the usage status value and a deletion allowance requirement,
wherein the determining the setting in the virtualized DU comprises:
determining that the virtualized DU is to be deleted if the usage status value is less than a first threshold value and the deletion allowance requirement is satisfied, and
determining that the virtualized DU is to be scaled in if the usage status value is less than the first threshold value and the deletion allowance requirement is not satisfied.

5. (canceled)
